(19) United States
(12) Patent Application Publication
(10) Pub. No.: US 2025/0341706 A1
(43) Pub. Date: Nov. 6, 2025

(54) PROJECTION LENS AND PROJECTION DEVICE

(71) Applicant: Goertek Optical Technology Co., Ltd., Weifang, Shandong (CN)

(72) Inventors: Fei Guo, Shandong (CN); Xianbin Wang, Shandong (CN)

(73) Assignee: Goertek Optical Technology Co., Ltd., Weifang, Shandong (CN)

(21) Appl. No.: 18/870,746

(22) PCT Filed: Jun. 28, 2022
(86) PCT No.: PCT/CN2022/102044

§ 371 Date: Dec. 2, 2024

(30) Foreign Application Priority Data
May 30, 2022 (CN) 202210604810.2

(51) Int. Cl. G02B 13/00; G02B 9/64; G02B 13/16

(52) U.S. Cl. CPC G02B 13/0045; G02B 9/64; G02B 13/16

(57) ABSTRACT

Embodiments of the present disclosure provides a projection lens and a projecting device; wherein, the projection lens comprises a front lens group, a rear lens group and a stop, sequentially from an object side to an image side along the same optical axis, wherein the stop is located between the front lens group and the rear lens group; wherein the front lens group has a focal length of f₁₁ satisfying: 40 mm<f₁₁<60 mm; the rear lens group has a focal length of f₂₂ satisfying: 2 mm<f₂₂<12 mm.

### CROSS-REFERENCE TO RELATED APPLICATIONS

The present disclosure is a National Stage of International Application No. PCT/CN2022/102044, filed on Jun. 28, 2022, which claims priority to a Chinese patent application No. 202210604810.2 filed with the CNIPA on May 30, 2022, both of which are hereby incorporated by reference in their entireties.

### TECHNICAL FIELD

Embodiments of the present disclosure relate to the technical field of projection imaging, and particularly to a projection lens and a projecting device.

### BACKGROUND

In recent years, with the rapid development of micro-projection technology, miniaturization has become a major trend in the development of micro-projection with the increasing demand for a portable micro-projection device. In the field of micro-projection technology, the micro-projection device is gradually developing towards miniaturization, portability and good imaging quality.

However, most of the optical structures of the current micro-projection lens are too complex and bulky to satisfy the miniaturization requirements on the miniature projection lens. Moreover, the light-emitting chip matched with the current miniature projection lens is large in size, such that the formed projection device is inconvenient to carry.

### SUMMARY

An objective of the present disclosure is to provide new technical solution for a projection lens and a projecting device.

In a first aspect, the present disclosure provides a projection lens. The projection lens comprises sequentially from an object side to an image side along the same optical axis: a front lens group, a rear lens group and a stop, wherein the stop is located between the front lens group and the rear lens group:
wherein the front lens group has a focal length of f₁₁ satisfying: 40 mm<f₁₁<60 mm:
the rear lens group has a focal length of f₂₂ satisfying: 2 mm<f₂₂<12 mm.

Optionally, an air space between the front lens group and the stop is set as A₁₁, and a ratio of A₁₁ to a total track length TTL of the projection lens is A₁₁/TTL satisfying: 0.033<A₁₁/TTL<0.167.

Optionally, an air space between the stop and the rear lens group is set as A₂₂, and a ratio of A₂₂ to a total track length TTL of the projection lens is A₂₂/TTL satisfying: 0.06<A₂₂/TTL<0.2.

Optionally, the projection lens further comprises a turning prism, which is located on a side of the rear lens group away from the stop: and
an air space between the rear lens group and the turning prism is A₃₃, and a ratio of A₃₃ to a total track length TTL of the projection lens is A₃₃/TTL satisfying: 0<A₃₃/TTL<2.

Optionally, the projection lens has a focal length of f satisfying: 3 mm<f<5 mm.

Optionally, the front lens group comprises a first lens with negative focal power and a second lens with positive focal power.

Optionally, the first lens has a focal length of f₁ satisfying: −8 mm<f₁<−4 mm; and
the second lens has a focal length of f₂ satisfying: 8 mm<f₂<12 mm.

Optionally, the rear lens group comprises a third lens, a fourth lens and a fifth lens arranged in sequence, wherein two adjacent surfaces of the third lens and the fourth lens are glued together;
the third lens has negative focal power, and the fourth lens and the fifth lens have positive focal power.

Optionally, the third lens has a focal length of f₃ satisfying: −18 mm<f₃<−14 mm;
the fourth lens has a focal length of f₄ satisfying: 15.5 m<f₄<19.5 mm;
the fifth lens has a focal length of f₅ satisfying: 7 mm<f₅<11 mm.

In a second aspect, the present disclosure provides a projecting device. The projecting device comprises:
a housing; and
the above projection lens, the projection lens being provided within the housing.

According to embodiments of the present disclosure, a projection lens is provided. The optical structure of the projection lens is designed to be relatively simple, can satisfy the requirement for small size for the projection lens, and can be matched with a small-sized light-emitting chip, which can reduce the volume and weight of the whole projection lens and make it easy to carry.

Other features and advantages of the present disclosure will become apparent from the following detailed description of exemplary embodiments of the present disclosure with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a first schematic structural diagram of a projection lens provided in an embodiment of the present disclosure;

FIG. 2 is an optical path diagram of the projection lens provided in FIG. 1;

FIG. 3 is a field curvature and distortion diagram of the projection lens provided in FIG. 1;

FIG. 4 is a modulation transfer function diagram of the projection lens provided in FIG. 1;

FIG. 5 is a defocused modulation transfer function diagram of the projection lens provided in FIG. 1;

FIG. 6 is a relative illumination diagram of the projection lens provided in FIG. 1;

FIG. 7 is a lateral chromatic aberration diagram of the projection lens provided in FIG. 1.

FIG. 8 is a second schematic structural diagram of a projection lens provided in an embodiment of the present disclosure;

FIG. 9 is a field curvature and distortion diagram of the projection lens provided in FIG. 8;

FIG. 10 is a modulation transfer function diagram of the projection lens provided in FIG. 8;

FIG. 11 is a defocused modulation transfer function diagram of the projection lens provided in FIG. 8;

FIG. 12 is a relative illumination diagram of the projection lens provided in FIG. 8;

FIG. 13 is a lateral chromatic aberration diagram of the projection lens provided in FIG. 8;

FIG. 14 is a third schematic structural diagram of a projection lens provided in an embodiment of the present disclosure;

FIG. 15 is a field curvature and distortion diagram of the projection lens provided in FIG. 14;

FIG. 16 is a modulation transfer function diagram of the projection lens provided in FIG. 14;

FIG. 17 is a defocused modulation transfer function diagram of the projection lens provided in FIG. 14;

FIG. 18 is a relative illumination diagram of the projection lens provided in FIG. 14;

FIG. 19 is a lateral chromatic aberration diagram of the projection lens provided in FIG. 14.

Description of reference signs:

10, front lens group; 11, first lens; 12, second lens; 20, rear lens group; 21, third lens; 22, fourth lens; 23, fifth lens; 30, stop; 40, image source; 50, turning prism; 60, light-transmitting protective component.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

Embodiments of the present disclosure provide a projection lens, which can be applied to a projecting device. The projection lens can be matched with a small-sized display, such as a digital micromirror device (DMD) of 0.16 inches, to form a projection lens with a smaller size, so as to satisfy the development trend of miniaturization of the projecting device.

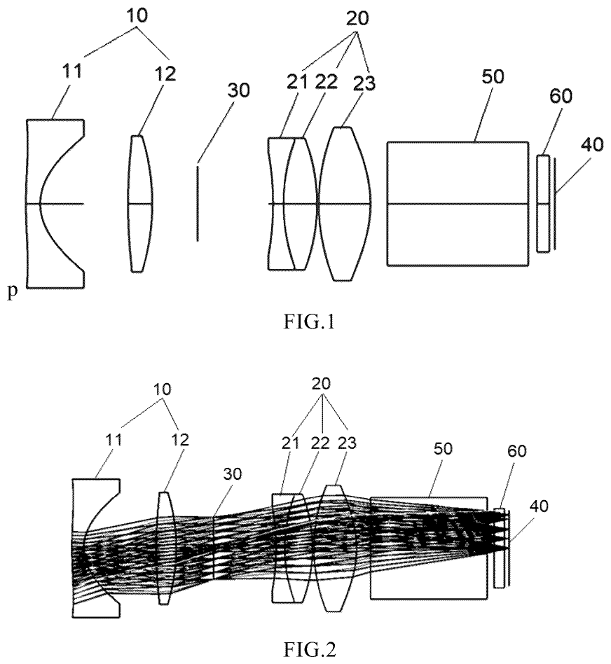

In the embodiments of the present disclosure, as shown in FIGS. 1 and 2, the projection lens sequentially includes from an object side to an image side along the same optical axis: a front lens group 10, a rear lens group 20 and a stop 30, wherein the stop 30 is located between the front lens group 10 and the rear lens group 20:
wherein the front lens group has a focal length of f₁₁ satisfying: 40 mm<f₁₁<60 mm:
the rear lens group has a focal length of f₂₂ satisfying: 2 mm<f₂₂<12 mm.

That is to say, in the projection lens provided by the embodiments of the present disclosure, its corresponding optical structure design takes the stop 30 as the dividing line, including two lens groups: one is the front lens group 10 placed proximate to the object side, and the other is the rear lens group 20 placed proximate to the image side. Moreover, the focal powers of both the front lens group and the rear lens group are positive.

It should be noted that the image side refers to the side where the light source, such as the image source 40 shown at the rightmost in FIGS. 1 and 2, of the projected image (or projection picture) is located during the projection process. Meanwhile, the object side refers to the side where the projection image is formed on the projection surface (e.g., a wall), as shown at the leftmost in FIGS. 1 and 2.

In the projection lens of the embodiments of the present disclosure, a light source, such as a display/screen which can emit projection light, may also be provided on the side of the rear lens group 20 away from the stop 30. The projection lens of the embodiments of the present disclosure may match small-sized displays, for example, a digital micromirror device (DMD) of 0.16 inches.

Here, the stop 30 is for example an aperture stop. The stop 30 may be used to limit the diameter of the projection light passing through, adjust the luminous flux emitted from the projection lens, and simultaneously reduce the interference of stray light generated by the reflection of other lenses, thereby making the imaging of the projection light clearer.

Typically, the aperture of the stop 30 is a fixed value. Of course, to flexibly adjust the clarity of the image and enable the projection lens to better adapt to switching between high and low resolutions, the stop 30 can also be set to allow adjustment of the aperture size.

The projection light is emitted by the above display, travels from the image side towards the object side, and after passing sequentially through the rear lens group 20, the stop 30, and the front lens group 10, is finally output to the projection surface on the object side, thus presenting the projected image.

According to embodiments of the present disclosure, a projection lens is provided. The optical structure of the projection lens is designed to be relatively simple, which can meet the requirement for small size for the projection lens, and can be matched with a small-sized light-emitting chip, thereby reducing the volume and weight of the entire projection lens and make it easy to carry.

In some examples of the present disclosure, an air space between the front lens group and the stop 30 is set as A₁₁, and a ratio of A₁₁ to a total track length TTL of the projection lens is A₁₁/TTL satisfying: 0.033<A₁₁/TTL<0.167.

In some examples of the present disclosure, an air space between the stop 30 and the rear lens group is set as A₂₂, and a ratio of A₂₂ to a total track length TTL of the projection lens is A₂₂/TTL satisfying: 0.06<A₂₂/TTL<b 0.2.

That is to say, the optical structure provided by the embodiments of the present disclosure appropriately adjusts the air space between the stop 30 and the front lens group 10, as well as the air space between the stop 30 and the rear lens group 20. The adjustment to the air spaces in front of and behind the stop 30 made according to the above constraints: (1) facilitates the cooperation between the lens and the lens barrel structure, is convenient for assembly, and may appropriately reduce the difficulty of manufacturing processes; (2) facilitates the reduction in the tolerance sensitivity of the lenses in front of and behind the stop 30, thereby improving the assembly yield of the entire projection lens; (3) facilitates the reduction in the off-axis edge aberrations of the projection lens, thereby enhancing the picture quality of the final projected image.

As shown in FIGS. 1 and 2, the projection lens may be paired with an image source 40, which, for example, may be a digital micromirror device (DMD) of 0.16 inches. The image source 40 is located on a side of the rear lens group 20 away from the stop 30, and may be used to project the projection light.

The projection lens provided by the embodiments of the present disclosure forms an optical structure that may match with the digital micromirror device (DMD) of 0.16 inches and be used in combination therewith. The offset of the present projection lens is 100%. When the side of the matched 0.16-inch DMD close to the optical axis is placed on the optical axis, the projection picture formed by the projection lens is located on a side of the optical axis away from the 0.16-inch DMD, and the side of the projection picture close to the optical axis is on the optical axis.

The projection lens provided by the embodiments of the present disclosure can be matched with the 0.16-inch DMD, and can greatly reduce the size of the entire projection lens while ensuring a better projection display, such that the projection lens provided by the embodiments of the present disclosure is smaller and more compact, thereby facilitating the miniaturization of the projecting device and making it more portable.

The DMD consists of many matrix-arranged digital micromirror devices. During operation, each micro-mirror is capable of deflecting and locking in both positive and negative directions, such that light is projected in a predetermined direction and oscillates at a frequency of tens of thousands of hertz, and thus the light beam from the illumination source is directed into the projection lens and imaged on the screen through the flipping and reflection of micromirrors. The DMD has advantages such as high resolution and no need for digital-to-analog conversion of signals.

In some examples of the present disclosure, as shown in FIGS. 1 and 2, the projection lens further includes a turning prism 50, which is located on a side of the rear lens group 20 away from the stop 30:
an air space between the rear lens group 20 and the turning prism 50 is A₃₃, and a ratio of A₃₃ to a total track length TTL of the projection lens is A₃₃/TTL satisfying: 0<A₃₃/TTL<2.

Here, the turning prism 50 has a thickness of 4 mm to 10 mm.

For example, the turning prism 50 may have a thickness of 8 mm.

The turning prism 50 may be used to combine the three color images of the light pulse signal emitted by the image source 40 paired with the projection lens, i.e., the 0.16-inch DMD, into one image, and transmit the corresponding projection light to the rear lens group and the front lens group for facilitating the display of the subsequent projection image.

In the embodiments of the present disclosure, an air space between the rear lens group 20 and the turning prism 50 is A₃₃, and a ratio of A₃₃ to a total track length TTL of the projection lens is A₃₃/TTL satisfying: 0<A₃₃/TTL<2. The purpose of this design is: (1) to leave sufficient assembly clearance between the projection lens and the main illumination body, facilitating structural design and manufacturing assembly, and improving mass production; (2) to facilitate the reduction in the tolerance sensitivity of the projection lens, thus increasing the assembly yield of the projection lens; (3) to facilitate the reduction in the length dimension of the projection lens, achieving a miniaturized design of the projection lens.

In some examples of the present disclosure, the projection lens has a focal length of f satisfying: 3 mm<f<5 mm.

In the embodiments of the present disclosure, by appropriately adjusting the effective focal length of the front lens group and the rear lens group, it is possible to optimize the effective focal length of the projection lens, which enables the projection light to be focused at an appropriate distance, and avoids the problem that the distance at which the projection light converges is too short, and the projection lens is too close to the projection surface, making it difficult for the projection light to form a large-scale projection picture. In this way, it is possible to further optimize the projection lens of embodiments of the present disclosure.

In some examples of the present disclosure, as shown in FIGS. 1 and 2, the front lens group 10 includes a first lens 11 and a second lens 12.

Optionally, the first lens 11 has a focal length of f₁ satisfying: −8 mm<f₁<−4 mm:
the second lens 12 has a focal length of f₂ satisfying: 8 mm<f₂<12 mm.

In the projection lens of the embodiments of the present disclosure, the first lens 11 has negative focal power, while the second lens 12 has positive focal power. That is, by pairing the first lens 11 with negative focal power and the second lens 12 with positive focal power, the design contributes to reducing the field curvature and the distortion generated during the optical imaging process. In other words, the focal power pairing design of the front lens group may reduce the field curvature and the distortion generated during the optical imaging process. For example, the distortion of the projection picture may be controlled to below 1%, which may well satisfy the eye level.

Here, focal power refers to the difference between the convergence degree of the light beam on the image side and that on the object side, which may be used to characterize the ability of an optical structure to polarize light. Here, lenses with negative focal power are generally thinner in the middle and thicker at the edges, which are also known as concave lenses and have the effect of diverging light. Here, lenses with positive focal power are generally thicker in the middle and thinner at the edges, which are also known as convex lenses and have the effect of converging light.

In some examples of the present disclosure, as shown in FIGS. 1 and 2, the rear lens group 20 includes a third lens 21, a fourth lens 22 and a fifth lens 23 arranged in sequence, wherein two adjacent surfaces of the third lens 21 and the fourth lens 22 are glued together.

Optionally, the third lens 21 has a focal length of f₃ satisfying: −18 mm<f₃<−14 mm:
the fourth lens 22 has a focal length of f₄ satisfying: 15.5 mm<f₄<19.5 mm:
the fifth lens 23 has a focal length of fs satisfying: 7 mm<f₅<11 mm.

In the projection lens of the embodiments of the present disclosure, the rear lens group 20 includes the third lens 21, the fourth lens 22, and the fifth lens 23; wherein the third lens 21 has negative focal power, and both the fourth lens 22 and the fifth lens 23 have positive focal power. By gluing the third lens 21 and the fourth lens 22 to form a double glued lens, it is possible to eliminate the chromatic aberration during the optical imaging process. For example, the chromatic aberration may be controlled to be less than 2 μm.

In a specific embodiment of the present disclosure, as shown in FIGS. 1 and 2, the projection lens sequentially includes along the same optical axis from the object side to the image side: the first lens 11, the second lens 12, the third lens 21, the fourth lens 22 and the fifth lens 23, wherein the first lens 11 has negative focal power, the second lens 12 has positive focal power, the third lens 21 has negative focal power, the fourth lens 22 has positive focal power, and the fifth lens 23 has positive focal power: the adjacent surfaces of the third lens 21 and the fourth lens 22 are glued to each other: the first lens 11 and the second lens 12 form the front lens group 10, and the third lens 21, the fourth lens 22, and the fifth lens 23 form the rear lens group 20, and both the front lens group 10 and the rear lens group 20 have positive focal power.

In the optical solution provided by the embodiments of the present disclosure, the projection light on the image side passes through the fifth lens 23, the fourth lens 22, the third lens 21, and the second lens 12 in sequence, and exits the projection lens from the first lens 11, which may enhance the brightness of the light passing through the projection lens.

In the projection lens provided by the embodiments of the present disclosure, a combination of only five lenses is used to form the projection lens. Due to the small number of lenses contained in this projection lens and its compact structure, it is possible to simplify the structure of the projection lens, and reduce the volume and weight of the projection lens, thereby satisfying the requirements for miniaturization of the projection lens. In the optical solution of the embodiment of the present disclosure, the number of lenses is relatively small compared to traditional solutions, and one glued lens is used in the optical path, thereby reducing production costs and assembly difficulty.

In the projection lens provided by the embodiments of the present disclosure, the cooperation among five different lenses effectively eliminates the aberrations generated during optical imaging, thereby ensuring imaging quality, such that the resulting projection lens has small distortion, small chromatic aberration, and good optical performance and enables the realization of a compact projection lens with high imaging quality.

Optionally, as shown in FIGS. 1 and 2, the surface of the first lens 11 facing the object side is convex, and the surface thereof facing the image side is concave; the surface of the second lens 12 facing the object side is convex, and the surface thereof facing the image side is also convex; the surface of the third lens 21 facing the object side is concave, and the surface thereof facing the image side is also concave; the surface of the fourth lens 22 facing the object side is convex, and the surface thereof facing the image side is also convex; the surface of the fifth lens 23 facing the object side is convex, and the surface thereof facing the image side is also convex.

That is to say, in the projection lens provided by the embodiments of the present disclosure: the first lens 11 is a concave-convex lens, which is a meniscus lens; the second lens 12 is a biconvex lens with positive focal power; the third lens 21 is a biconcave lens with negative focal power; the fourth lens 22 is a biconvex lens with positive focal power; the fifth lens 23 is a biconvex lens with positive focal power; wherein the concave surface of the third lens 21 and the convex surface of the fourth lens are glued to each other. The design of the entire optical path structure is compact, which facilitates the miniaturization of the projection lens. Additionally, this optical path structure design may expand the field angle of the projection lens reaching over 28°, achieving a large field of view effect.

Optionally, the radius of curvature R₁ of the convex surface of the first lens 11 satisfies: 5<R₁<50, and the radius of curvature R₂ of the concave surface of the first lens 11 satisfies: 1<R₂<20.

Optionally, the radius of curvature R₃ of the convex surface of the second lens 12 satisfies: 5<R₃<60, and the radius of curvature R₄ of the concave surface of the second lens 12 satisfies: −30<R₄<−5.

Optionally, the radius of curvature R₅ of the convex surface of the third lens 21 satisfies: −50<R₅<−5, and the radius of curvature R₆ of the concave surface of the third lens 21 satisfies: 2<R₆<30.

Optionally, the radius of curvature R₇ of the convex surface of the fourth lens 22 satisfies: 2<R₇<30, and the radius of curvature R₈ of the concave surface of the fourth lens 22 satisfies: −30<R₈<−5.

Optionally, the radius of curvature R₉ of the convex surface of the fifth lens 23 satisfies: 2<R₉<50, and the radius of curvature Rio of the concave surface of the fifth lens 23 satisfies: −30<R₁₀<−1.

By constraining the radius of curvature of each surface of each lens, it is not only possible to reduce the manufacturing difficulty of the lens, but also beneficial to reducing the tolerance sensitivity of the projection lens, thereby improving the yield of the lens assembly of the final lens.

In the entire optical structure, to further ensure that the converging projection light of the rear lens group 20 achieves short-distance projection effects, in the rear lens group of the projection lens, the light-incident surface and the light-emergent surface of the fifth lens 23 are both designed as convex surfaces, and the light-incident surface and the light-emergent surface of the fourth lens 22 are also designed as convex surfaces, while the light-incident surface and the light-emergent surface of the third lens 21 are designed as concave surfaces. That is, both the fifth lens 23 and the fourth lens 22 adopt biconvex lenses, which may cause the projection light to deflect at a large angle, and thus shorten the focus position of the projection light. The third lens 21 adopts the biconcave lens, which may effectively disperse the projection light, and such design may increase the size of the projection picture.

To further ensure the effective dispersion of the light in the front lens group, both the light-incident surface and the light-emergent surface of the second lens 12 are designed as the convex surfaces, while the light-incident surface of the first lens 11 is designed as the curved concave surface, and the light-emergent surface of the first lens 11 is designed as a convex surface with a certain curvature. That is, the second lens 12 adopts the biconvex lens, may cause the light to deflect at a large angle through the biconvex lens, and may shorten the focus position of the light. The first lens 11 adopts a design where the light-incident surface is concave and the light-emergent surface is convex, and thus when the projection light passes through the first lens 11, it is incident into the concave surface and emergent from the convex surface, which may converge the light beam and further adjust the propagation path of the projection light, such that a clear image may be projected onto the projection surface.

In the embodiments of the present disclosure, all lenses in the front lens group and the rear lens group may be made of glass material.

Due to the cost advantage of glass material, it is possible to reduce the manufacturing cost of the entire projection lens. At the same time, the heat-resistant property of glass material is also utilized. The glass material has a low thermal distortion rate and high stability, and therefore, various lenses in the optical path may be designed as glass material, especially the lenses in the rear lens group close to the image source 40 may be set as glass material, thus avoiding the impact of high temperatures on the projection lens.

Of course, those skilled in the art may appropriately select the material of each lens in the projection lens according to specific needs, which is not limited in the embodiments of the present disclosure.

In one specific embodiment of the present disclosure, the first lens 11 has a focal length of f₁ satisfying: −8 mm<f₁<−4 mm: the second lens 12 has a focal length of f₂ satisfying: 8 mm<f₂<12 mm: the third lens 21 has a focal length of f₃ satisfying: −18 mm<f₃<−14 mm; the fourth lens 22 has a focal length of fa satisfying: 15.5 mm<f₄<19.5 mm; the fifth lens 23 has a focal length of fs satisfying: 7 mm<f₅<11 mm.

In the embodiments of the present disclosure, the projection light may be converged after passing through the fifth lens 23, the fourth lens 22, and the third lens 21 in sequence. If the focal length of the fifth lens 23 is too small, for example, less than 7 mm, it will result in a too short projection distance, which may make it difficult to form a larger-sized image. However, if the focal length of the fifth lens 23 is too large, for example, greater than 11 mm, it will lead to a too long projection distance, making it difficult to form a projection picture within a limited space and causing the size of the entire projection lens to be too long. These are all undesirable. Therefore, in the embodiments of the present disclosure, the focal length f₅ of the fifth lens 23 is set between 7 mm and 11 mm. Similarly, the focal length f₄ of the fourth lens 22 is set between 15.5 mm and 19.5 mm, and the focal length f₃ of the third lens 21 is set between −18mm and −14 mm, all aiming to enable the projection light to form a properly sized and clear image.

In the embodiments of the present disclosure, the projection light, after emerging from the rear lens group, passes successively through the second lens 12 and the first lens 11 before diverging. It should be noted that to avoid excessive divergence of the projection light, the focal length f₂ of the second lens 12 is set to be greater than 8 mm, and to ensure that the size of the projection picture is large enough to satisfy the user's viewing requirements, the focal length f₂ of the second lens 12 should be less than 12 at the same time. Similarly, to avoid excessive divergence of light, the focal length f₁ of the first lens 11 is greater than −8 mm, and to ensure that the size of the projection picture satisfies the requirements, the focal length f₁ of the first lens 11 must also satisfy being less than −4 mm. The focal lengths of the first lens 11 and the second lens 12 are appropriately adjusted to enable the projection light to be focused at an appropriate distance, and to avoid the problem that the distance at which the projection light converges is too short, and the projection lens is too close to the projection surface, making it difficult for the projection light to form a large-scale projection picture.

The projection lens provided by the embodiments of the present disclosure, with the focal power of each lens evenly distributed, ensures that the tolerance sensitivity of each lens is low, thereby improving the yield of the projection lens and facilitating mass production.

In some examples of the present disclosure, the ratio of the thickness T₁ of the first lens 11 to the total track length TTL of the projection lens is T₁/TTL, wherein T₁/TTL satisfies: 0.015<T₁/TTL<0.067;
the ratio of the thickness T₂ of the second lens 12 to the total track length TTL of the projection lens is T₂/TTL, wherein T₂/TTL satisfies: 0.027<T₂/TTL<0.1;
the ratio of the thickness T₃ of the third lens 21 to the total track length TTL of the projection lens is T₃/TTL, wherein T₃/TTL satisfies: 0.01<T₃/TTL<0.067;
the ratio of the thickness T₄ of the fourth lens 22 to the total track length TTL of the projection lens is T₄/TTL, wherein T₄/TTL satisfies: 0.033<T₄/TTL<0.133;
the ratio of the thickness T₅ of the fifth lens 23 to the total track length TTL of the projection lens is T₅/TTL, wherein T₅/TTL satisfies: 0.067<T₅/TTL<0.167.

By limiting the thickness of each lens in the projection lens: (1) the length/dimension of the formed projection lens may be controlled to achieve miniaturization while controlling the quality of the projection picture; (2) raw materials may be saved appropriately, reducing production costs; (3) it is beneficial to reduce the difficulty of the manufacturing process of the lenses.

Optionally, the air space between the first lens 11 and the second lens 12 is A₁, and the ratio of A₁ to the total track length TTL of the projection lens is A₁/TTL, wherein A₁/TTL satisfies: 0.067<A₁/TTL<0.233;
the air space between the third lens 21 and the fourth lens 22 is A₃, and the ratio of A₃ to the total track length TTL of the projection lens is A₃/TTL, wherein A₃/TTL satisfies: 0<A₃/TTL<0.5;
the air space between the fourth lens 22 and the fifth lens 23 is A₄, and the ratio of A₄ to the total track length TTL of the projection lens is A₄/TTL, wherein A₄/TTL satisfies: 0<A₄/TTL<1.

Optionally, as shown in FIGS. 1 and 2, the projection lens further includes a light-transmitting protective component 60, which is located between the turning prism 50 and the image source 40.

Here, the light-transmitting protective component 60 may be a transparent glass plate. For example, the transparent glass plate may be placed over the light-emergent surface of the image source 40, which effectively protects the image source 40 and prevents dust from entering the image source 40 while ensuring high light transmittance.

Optionally, the first lens 11 and the fifth lens 23 are aspherical lenses; the second lens 12, the third lens 21, and the fourth lens 22 are spherical lenses.

In the solution of the embodiments of the present disclosure, among the five lenses in the entire projection lens, only two aspherical lenses are used. Compared to other projection lenses that use three or more aspherical lenses, the projection lens of the embodiment of the present disclosure achieves the purpose of reducing the production cost by reducing the number of aspheric lenses, while ensuring the image quality with high definition and low distortion.

For example, both surfaces of the first lens 11 are aspherical, and by having different curvatures at the center and edge positions, it is possible to reduce aberrations, making the image clearer and contributing to the miniaturization of the projection lens. Both surfaces of the fifth lens 23, for example, are aspherical, and this design may effectively eliminate spherical aberration, coma, and astigmatism generated during the optical imaging process, achieving the effect of correcting aberrations.

The projection lens provided by the embodiments of the present disclosure may achieve an image height greater than 4 mm, an F-number greater than 1.5, a transmission ratio greater than 1, and a field angle greater than 30°.

Here, the F-number refers to the aperture ratio of the projection lens. Specifically, the aperture ratio refers to the ratio of the focal length to the aperture diameter. When the aperture ratio is smaller, the relative aperture of the projection lens is larger, and the amount of light throughput is greater; when the aperture ratio is larger, the relative aperture of the projection lens is smaller, and the amount of light throughput is less. The projection lens of the present disclosure has a large aperture F, which greatly satisfies the requirement for brightness of the projection lens.

Here, the throw ratio refers to a ratio of the projection distance to the width of the projection picture.

Here, the field angle, also known as the field of view in optical engineering, determines the range of vision of optical instruments, and may be represented as FOV. The projection lens of the present disclosure has a large field angle.

To further optimize the performance of the projection lens, the following three examples are provided for illustration.

### First Embodiment

As shown in FIGS. 1 and 2, the projection lens sequentially includes along the same optical axis from the object side to the image side: the first lens 11, the second lens 12, the third lens 21, the fourth lens 22, and the fifth lens 23. The first lens 11 and the third lens 21 both have negative focal power, while the second lens 12, the fourth lens 22, and the fifth lens 23 all have positive focal power. The adjacent surfaces of the third lens 21 and the fourth lens 22 are glued to each other. The first lens 11 and the second lens 12 form the front lens group 10, and the third lens 21, the fourth lens 22, and the fifth lens 23 form the rear lens group 20. The focal length of the front lens group 10 is f₁₁, wherein f₁₁ satisfies: 40 mm<f₁₁<60 mm; the focal length of the rear lens group 20 is f₂₂, wherein f₂₂ satisfies: 2 mm<f₂₂<12 mm. The stop 30 is provided between the front lens group 10 and the rear lens group 20.

The surface of the first lens 11 facing the object side is convex, and the surface thereof facing the image side is concave; the surface of the second lens 12 facing the object side is convex, and the surface thereof facing the image side is also convex; the surface of the third lens 21 facing the object side is concave, and the surface thereof facing the image side is also concave; the surface of the fourth lens 22 facing the object side is convex, and the surface thereof facing the image side is also convex: the surface of the fifth lens 23 facing the object side is convex, and the surface thereof facing the image side is also convex; the first lens 11 and the fifth lens 23 are aspherical lenses: the second lens 12, the third lens 21, and the fourth lens 22 are spherical lenses.

The projection lens may be paired with an image source 40, which is a 0.16-inch DMD, is located on the side of the fifth lens 23 away from the fourth lens 22, and is used to project the projection light;
the projection lens further includes a turning prism 50, which is located between the fifth lens 23 and the image source 40, and has a thickness of 8 mm.

The projection lens further includes a light-transmitting protective component 60, which is located between the turning prism 50 and the image source 40;
the projection lens has a total track length of 30 mm.

Refer to Table 1 below, which includes the radius of curvature, thickness, material, and semi-diameter of each lens. Here, the thickness at the interval positions represents the distance between adjacent lenses.

TABLE 1
Basic Parameters Of Optical Design

| | | | Radius | | Optical | |
|---|---|---|---|---|---|---|
| | Des- | Type of | Of Cur- | Thick- | Material | Semi- |
| No. | cription | Surface | vature | ness | (Nd; Vd) | diameter |
| OBJ | | Spherical | Infinity | 1000 | | 629.612 |
| | | Surface | | | | |
| 10 | First | Even- | 26.178 | 0.812 | 1.53; 55.8 | 4.77 |
| | Lens | order | | | | |
| | | Aspheric | | | | |
| | | Surface | | | | |
| | | Even- | 2.851 | 4.985 | | 3.84 |
| | | order | | | | |
| | | Aspheric | | | | |
| | | Surface | | | | |
| 20 | Second | Spherical | 31.992 | 1.374 | 1.90; 31.3 | 3.5 |
| | Lens | Surface | | | | |
| | | Spherical | −12.981 | 2.569 | | 3.86 |
| | | Surface | | | | |
| STOP | | Spherical | Infinity | 4.289 | | 2.13 |
| | | Surface | | | | |
| 30 | Third | Spherical | −15.880 | 0.595 | 1.81; 25.5 | 2.87 |
| | Lens | Surface | | | | |
| 40 | Fourth | Spherical | 10.449 | 1.899 | 1.69; 54.6 | 3.53 |
| | Lens | Surface | | | | |
| | | Spherical | −10.370 | 0.1 | | 3.73 |
| | | Surface | | | | |
| 50 | Fifth | Aspheric | 10.704 | 2.933 | 1.50; 81.5 | 4.3 |
| | Lens | Surface | | | | |
| | | Aspheric | −6.985 | 0.957 | | 4.36 |
| | | Surface | | | | |
| 80 | Turning | Spherical | Infinity | 8 | 1.72; 29.5 | 3.054 |
| | Prism | Surface | | | | |
| | | Spherical | Infinity | 0.5 | | 2.797 |
| | | Surface | | | | |
| 90 | Light- | Spherical | Infinity | 0.7 | 1.51; 62.9 | 2.721 |
| | trans- | Surface | | | | |
| | mitting | | | | | |
| | Protective | | | | | |
| | Com- | | | | | |
| | ponent | | | | | |
| | | Spherical | Infinity | 0.303 | | 2.651 |
| | | Surface | | | | |
| 70 | Image | Spherical | Infinity | | | 2.605 |
| | Source | Surface | | | | |

According to the first embodiment provided by the present disclosure:
the throw ratio of the projection lens is 1.2.

The F-number of the projection lens is 1.8. The F-number refers to the aperture ratio of the projection lens, with a large aperture of F no. 1.8, which significantly satisfies the requirements on brightness of the projection lens.

The field angle of the projection lens satisfies: FOV=32.1°, providing a wide field angle.

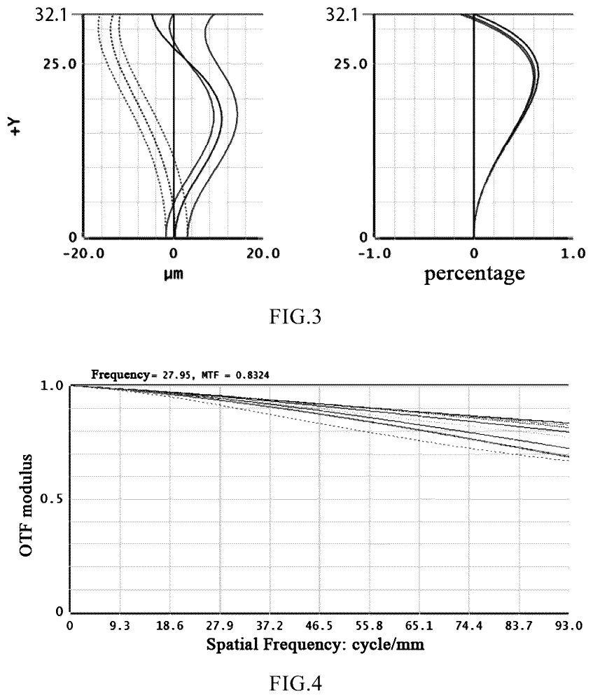

Based on the data in Table 1, as shown in FIG. 3, it shows the field curvature and distortion diagrams of the projection lens. Here, the field curvature refers to the image field curvature, mainly indicating the degree of misalignment between the intersection of the entire light beam and the ideal image point in the projection lens. The distortion refers to the aberration where different parts of an object have different magnifications when imaged through the projection lens. The distortion degrades the similarity of the object image but does not affect the clarity of the image. According to FIG. 3, it can be seen the distortion is less than 1%, satisfying the requirements for human eye viewing.

Based on the data in Table 1, as shown in FIG. 4, it shows the modulation transfer function (MTF) diagram of the projection lens for various fields of view on the chip surface. The MTF diagram represents the relationship between modulation and the line pairs per millimeter in the image, and is used to evaluate the ability to reproduce fine details of the scene. According to FIG. 4, it can be seen when the image source 40 in the projection lens is 0.16 inches, the projection angle is taken as the spatial frequency coordinate for the field sampling, and the vertical coordinate represents the transfer function MTF value. According to FIG. 4, MTF is greater than 0.6, indicating good imaging quality.

Based on the data in Table 1, as shown in FIG. 5, it shows the defocused MTF diagram of the projection lens. The defocus range where MTF>0.4 is greater than 0.025 mm, providing a wide defocus range and low thermal defocus risk, and can adapt to unstable lighting environments.

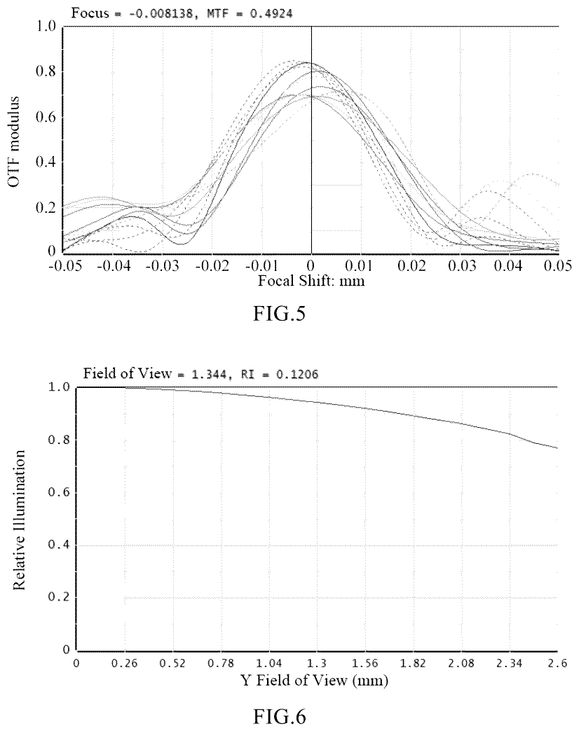

Based on the data in Table 1, as shown in FIG. 6, it shows the relative illumination diagram of the projection lens. The relative illumination at the edge compared to the center is greater than 78%, indicating uniform brightness across the imaging scene of the projection lens, minimal light energy loss at the edges, and high utilization of illumination light.

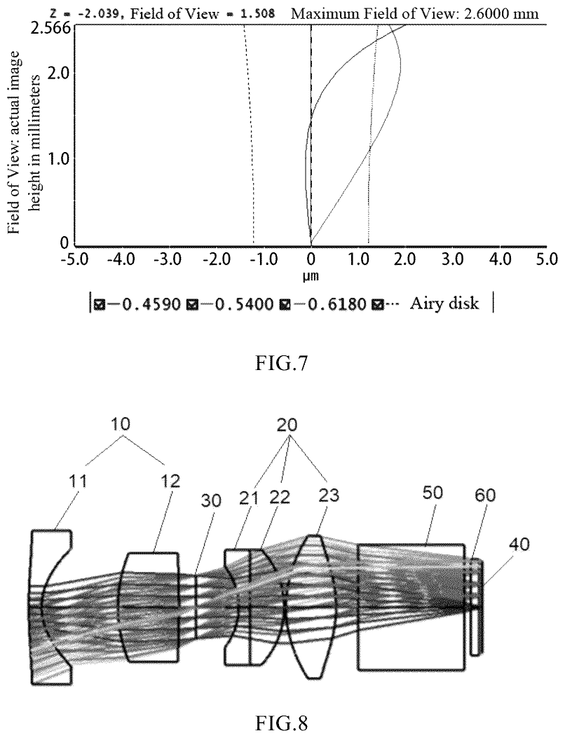

Based on the data in Table 1, as shown in FIG. 7, it shows the lateral chromatic aberration diagram of the projection lens. The lateral chromatic aberration, also known as magnification chromatic aberration, mainly refers to the difference in focal positions of hydrogen blue light and hydrogen red light on the image surface since one polychromatic principal ray of the image side becomes multiple rays when emerging from the object side due to the dispersion of the refraction system. According to FIG. 7, the lateral chromatic aberration of the projection lens is less than 2 μm, resulting in extremely low imaging trailing and good imaging quality.

### Second Embodiment

As shown in FIG. 8, the projection lens is different from the first embodiment in that:

Refer to Table 1 below, which includes the radius of curvature, thickness, material, and semi-diameter of each lens. Here, the thickness at the interval positions represents the distance between adjacent lenses.

TABLE 2
Basic Parameters Of Optical Design

| | | | Radius | | Optical | |
|---|---|---|---|---|---|---|
| | Des- | Type of | Of | Thick- | Material | Semi- |
| No. | cription | Surface | Curvature | ness | (Nd; Vd) | diameter |
| OBJ | | Spherical | Infinity | 1000 | | 630.201 |
| | | Surface | | | | |
| 10 | First | Even-order | 23.907 | 0.592 | 1.53; 55.8 | 4.653 |
| | Lens | Aspheric | | | | |
| | | Surface | | | | |
| | | Even-order | 3.12 | 3.407 | | 3.3 |
| | | Aspheric | | | | |
| | | Surface | | | | |
| 20 | Second | Spherical | 8.38 | 1.515 | 1.90; 31.3 | 3.626 |
| | Lens | Surface | | | | |
| S4 | | Spherical | −66.194 | 2.838 | | 3.478 |
| | | Surface | | | | |
| STOP | | Spherical | Infinity | 1.93 | | 1.706 |
| | | Surface | | | | |
| 30 | Third | Spherical | −4.094 | 0.597 | 1.81; 25.5 | 2.18 |
| | Lens | Surface | | | | |
| 40 | Fourth | Spherical | Infinity | 2.342 | 1.69; 54.6 | 2.764 |
| | Lens | Surface | | | | |
| | | Spherical | −5.09 | 0.1 | | 3.331 |
| | | Surface | | | | |
| 50 | Fifth | Aspheric | 6.207 | 2.895 | 1.50; 81.5 | 4 |
| | Lens | Surface | | | | |
| | | Aspheric | −7.195 | 1.272 | | 4.181 |
| | | Surface | | | | |
| 80 | turning | Spherical | Infinity | 6.5 | 1.72; 29.5 | 3.662 |
| | prism | Surface | | | | |
| | | Spherical | Infinity | 0.338 | | 2.788 |
| | | Surface | | | | |
| 90 | light- | Spherical | Infinity | 0.48 | 1.51; 62.9 | 2.709 |
| | trans- | Surface | | | | |
| | mitting | | | | | |
| | pro- | | | | | |
| | tective | | | | | |
| | com- | | | | | |
| | ponent | | | | | |
| | | Spherical | Infinity | 0.205 | | 2.636 |
| | | Surface | | | | |
| 70 | Image | Spherical | Infinity | — | | 2.657 |
| | Source | Surface | | | | |

According to the second embodiment provided by the present disclosure:
the throw ratio of the projection lens is 1.2.

The F-number of the projection lens is 1.7. The F-number refers to the aperture ratio of the projection lens, with a large aperture of F no. 1.7, which significantly satisfies the requirements on brightness of the projection lens.

The field angle of the projection lens satisfies: FOV=32°, providing a wide field angle.

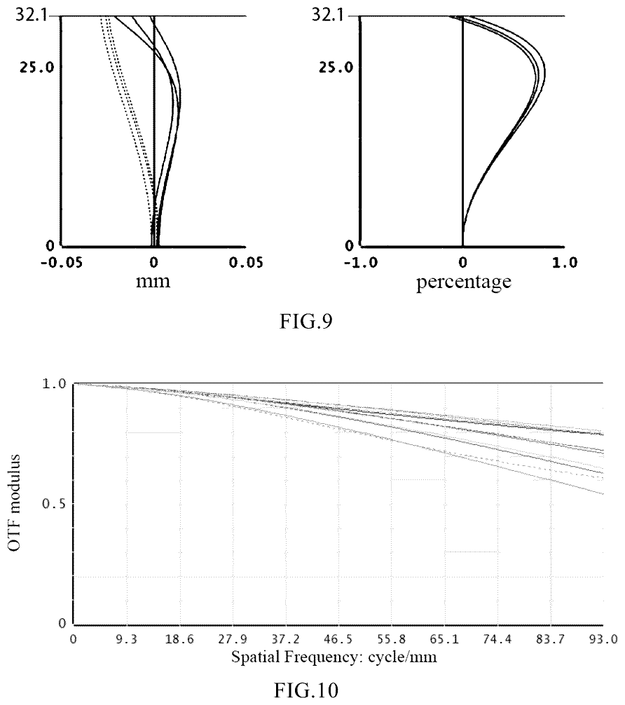

Based on the data in Table 2, as shown in FIG. 9, it shows the field curvature and distortion diagrams of the projection lens. According to FIG. 9, it can be seen the distortion is less than 0.9%, satisfying the requirements for human eye viewing.

Based on the data in Table 2, as shown in FIG. 10, it shows the modulation transfer function (MTF) diagram of the projection lens for various fields of view on the chip surface. According to FIG. 10, it can be seen when the image source 40 in the projection lens is 0.16 inches, the projection angle is taken as the spatial frequency coordinate for the field sampling, and the vertical coordinate represents the transfer function MTF value. MTF is greater than 0.6, indicating good imaging quality.

Based on the data in Table 2, as shown in FIG. 11, it shows the defocused MTF diagram of the projection lens. The defocus range where MTF>0.4 is greater than 0.016 mm, providing a wide defocus range and low thermal defocus risk, and adapting to unstable lighting environments.

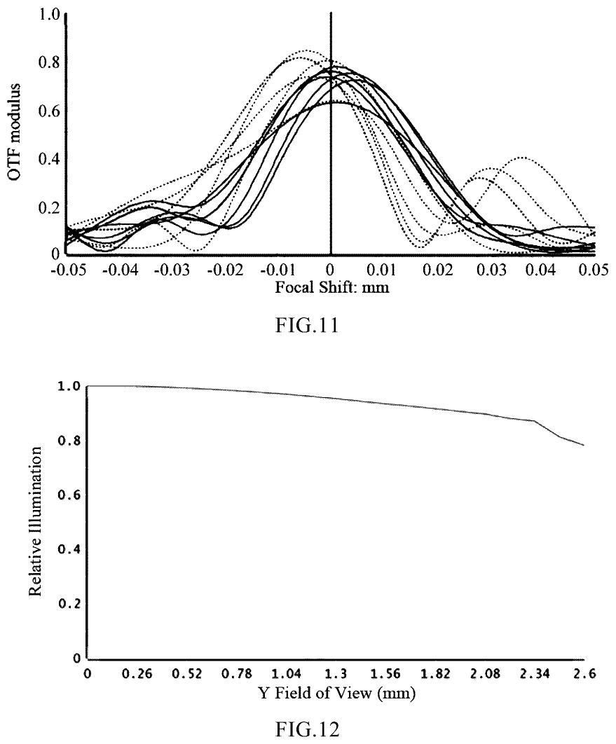

Based on the data in Table 2, as shown in FIG. 12, it shows the relative illumination diagram of the projection lens. The relative illumination at the edge compared to the center is greater than 78%, indicating uniform brightness across the imaging scene of the projection lens, minimal light energy loss at the edges, and high utilization of illumination light.

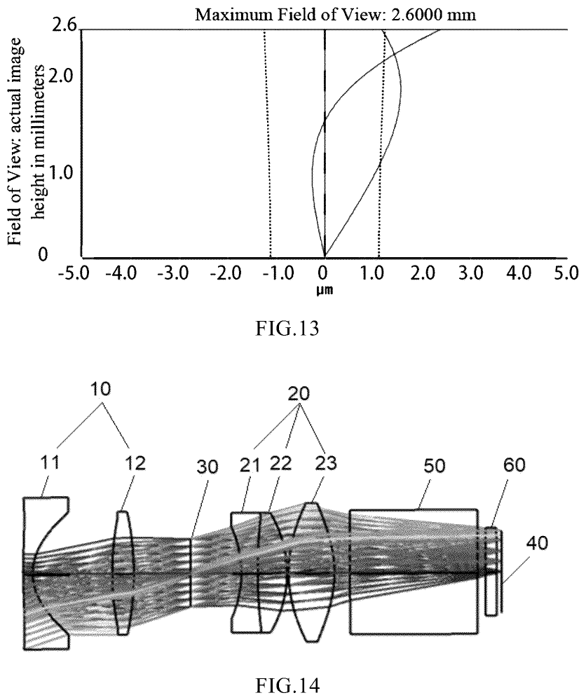

Based on the data in Table 2, as shown in FIG. 13, it shows the lateral chromatic aberration diagram of the projection lens. According to FIG. 13, the lateral chromatic aberration of the projection lens is less than 2.3 μm, resulting in good imaging quality.

### Third Embodiment

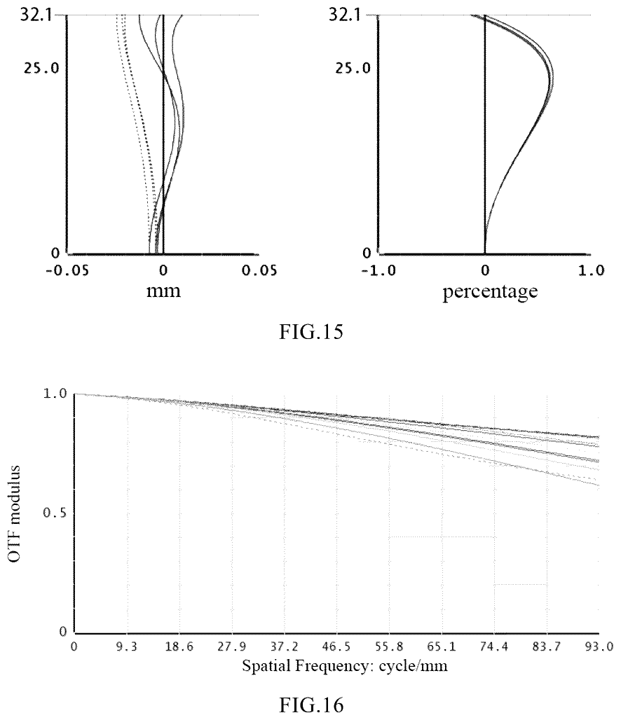

As shown in FIG. 14, the projection lens is different from the first embodiment in that:

Refer to Table 3 below, which includes the radius of curvature, thickness, material, and semi-diameter of each lens. Here, the thickness at the interval positions represents the distance between adjacent lenses.

The total track length of the projection lens is also 30 mm.

TABLE 3
Basic Parameters Of Optical Design

| | | | Radius | | Optical | |
|---|---|---|---|---|---|---|
| | Des- | Type of | Of | Thick- | Material | Semi- |
| No. | cription | Surface | Curvature | ness | (Nd; Vd) | diameter |
| OBJ | | Spherical | Infinity | 1000 | | 630 |
| | | Surface | | | | |
| 10 | First Lens | Even- | 34.664 | 0.591 | 1.53; 55.8 | 4.77 |
| | | order | | | | |
| | | Aspheric | | | | |
| | | Surface | | | | |
| | | Even- | 3.186 | 5 | | 3.84 |
| | | order | | | | |
| | | Aspheric | | | | |
| | | Surface | | | | |
| 20 | Second | Spherical | 18.058 | 1.351 | 1.90; 31.3 | 3.5 |
| | Lens | Surface | | | | |
| | | Spherical | −18.284 | 3.55 | | 3.86 |
| | | Surface | | | | |
| STOP | | Spherical | Infinity | 3.195 | | 2.13 |
| | | Surface | | | | |
| 30 | Third | Spherical | −7.043 | 1.027 | 1.81; 25.5 | 2.87 |
| | Lens | Surface | | | | |
| 40 | Fourth | Spheric | 31.346 | 1.836 | 1.69; 54.6 | 3.53 |
| | Lens | Surface | | | | |
| | | Spherical | −7.350 | 0.1 | | 3.765 |
| | | Surface | | | | |
| 50 | Fifth | Aspheric | 6.168 | 2.884 | 1.50; 81.5 | 4.3 |
| | Lens | Surface | | | | |
| | | Aspheric | −7.232 | 0.968 | | 4.36 |
| | | Surface | | | | |
| 80 | turning | Spherical | Infinity | 8 | 1.72; 29.5 | 3.054 |
| | prism | Surface | | | | |
| | | Spherical | Infinity | 0.5 | | 2.797 |
| | | Surface | | | | |
| 90 | light- | Spherical | Infinity | 0.7 | 1.51; 62.9 | 2.721 |
| | trans- | Surface | | | | |
| | mitting | | | | | |
| | protective | | | | | |
| | com- | | | | | |
| | ponent | | | | | |
| | | Spherical | Infinity | 0.303 | | 2.651 |
| | | Surface | | | | |
| 70 | Image | Spherical | Infinity | — | | 2.605 |
| | Source | Surface | | | | |

According to the third embodiment provided by the present disclosure:
the throw ratio of the projection lens is 1.2.

The F-number of the projection lens is 1.8. The F-number refers to the aperture ratio of the projection lens, with a large aperture of F no. 1.8, which significantly satisfies the requirements on brightness of the projection lens.

The field angle of the projection lens satisfies: FOV=32.1°, providing a wide field angle.

Based on the data in Table 3, as shown in FIG. 15, it shows the field curvature and distortion diagrams of the projection lens. According to FIG. 15, it can be seen the distortion is less than 0.95%, satisfying the requirements for human eye viewing.

Based on the data in Table 3, as shown in FIG. 16, it shows the modulation transfer function (MTF) diagram of the projection lens for various fields of view on the chip surface. According to FIG. 16, it can be seen when the image source 40 in the projection lens is 0.16 inches, the projection angle is taken as the spatial frequency coordinate for the field sampling, and the vertical coordinate represents the transfer function MTF value. MTF is greater than 0.6, indicating good imaging quality.

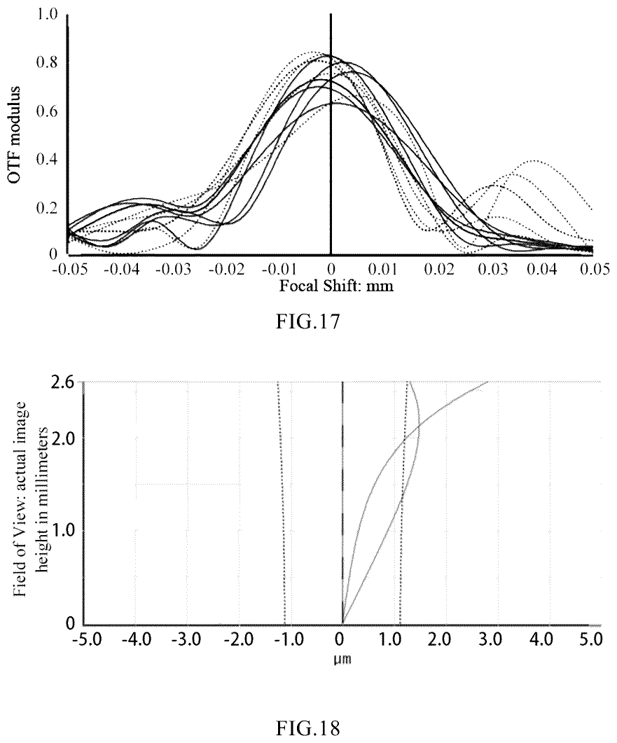

Based on the data in Table 3, as shown in FIG. 17, it shows the defocused MTF diagram of the projection lens. The defocus range where MTF>0.4 is greater than 0.002 mm, providing a wide defocus range and low thermal defocus risk, and adapting to unstable lighting environments.

Based on the data in Table 3, as shown in FIG. 18, it shows the relative illumination diagram of the projection lens. The relative illumination at the edge compared to the center is greater than 80%, indicating uniform brightness across the imaging scene of the projection lens, minimal light energy loss at the edges, and high utilization of illumination light.

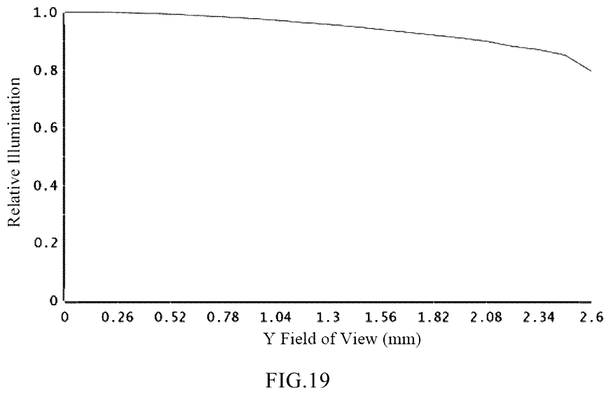

Based on the data in Table 3, as shown in FIG. 19, it shows the lateral chromatic aberration diagram of the projection lens. According to FIG. 19, the lateral chromatic aberration of the projection lens is less than 2.7 μm, resulting in good imaging quality.

The embodiments of the present disclosure also provide a projecting device, which includes a housing and the above projection lens, wherein the projection lens is provided within the housing.

The specific structure of the projection lens may refer to the above various embodiments.

Since the projecting device of the present disclosure adopts the projection lens described in all the above embodiments, it therefore at least possesses all the beneficial effects brought by the technical solutions of those embodiments, which will not be repeated here.

The preceding embodiments focus on describing the differences between each embodiment. The different optimizing features of each embodiment can be combined to form even more optimal embodiments as long as they do not conflict. For the sake of brevity, these combinations will not be elaborated upon here.

1. A projection lens, comprising sequentially a front lens group, a rear lens group, and a stop, from an object side to an image side along a single optical axis, wherein the stop is located between the front lens group and the rear lens group;
wherein the front lens group has a focal length of f₁₁ satisfying: 40 mm<f₁₁<60 mm;
the rear lens group has a focal length of f₂₂ satisfying: 2 mm<f₂₂<12 mm.

2. The projection lens according to claim 1, wherein an air space between the front lens group and the stop is set as A₁₁, and a ratio of A₁₁ to a total track length TTL of the projection lens is A₁₁/TTL satisfying: 0.033<A₁₁/TTL<0.167.

3. The projection lens according to claim 1, wherein an air space between the stop and the rear lens group is set as A₂₂, and a ratio of A₂₂ to a total track length TTL of the projection lens is A₂₂/TTL satisfying: 0.06<A₂₂/TTL<0.2.

4. The projection lens according to claim 1, further comprises a turning prism, located on a side of the rear lens group away from the stop, and
wherein an air space between the rear lens group and the turning prism is A₃₃, and a ratio of A₃₃ to a total track length TTL of the projection lens is A₃₃/TTL satisfying: 0<A₃₃/TTL<2.

5. The projection lens according to claim 1, wherein the projection lens has a focal length of f satisfying: 3 mm<f<5 mm.

6. The projection lens according to claim 1, wherein the front lens group comprises a first lens with a negative focal power and a second lens with a positive focal power.

7. The projection lens according to claim 6, wherein the first lens has a focal length of f₁ satisfying: −8 mm<f₁<−4 mm; and
the second lens has a focal length of f₂ satisfying: 8 mm<f₂<12 mm.

8. The projection lens according to claim 1, wherein the rear lens group comprises a third lens, a fourth lens, and a fifth lens arranged in sequence, wherein two adjacent surfaces of the third lens and the fourth lens are glued together; and
the third lens has a negative focal power, and the fourth lens and the fifth lens have a positive focal power.

9. The projection lens according to claim 8, wherein the third lens has a focal length of f₃ satisfying: −18 mm<f₃<−14 mm;
the fourth lens has a focal length of f₄ satisfying: 15.5 mm<f₄<19.5 mm;
the fifth lens has a focal length of f₅ satisfying: 7 mm<f₅<11 mm.

10. A projecting device, comprising: a housing; and a projection lens according to claim 1, the projection lens being provided within the housing.
